(19) United States
(12) Patent Application Publication
(10) Pub. No.: US 2005/0253827 A1
(43) Pub. Date: Nov. 17, 2005

(54) Digital video signal processing devices for liquid crystal displays

(75) Inventors: Chi-Mao Hung, Chiayi City (TW); Jung-Hsiu Tsai, Caotun Township (TW); Chien-Chih Chen, Jhudong Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/042,896

(22) Filed: Jan. 25, 2005

(30) Foreign Application Priority Data
May 14, 2004 (TW) 93113622

(51) Int. Cl. G09G 3/36

(52) U.S. Cl. 345/204

(57) ABSTRACT

A digital video signal processing device. A display memory stores a digital image signal. A scaler locates on a circuit board for adjusting image size corresponding to the digital image signal, and outputs a first display data. An LCD panel includes a plurality of display cells respectively coupled to corresponding data electrode and gate electrode, for displaying an image according to a second display data. An LCD driving circuit includes a data driver and a gate driver for respectively driving the corresponding data electrodes and gate electrodes. A gamma correction locates only on the circuit board for adjusting gamma values of the first display data and outputting the second display data according to the adjustment result.

### BACKGROUND

The present disclosure relates in general to digital video signal processing devices. In particular, the present disclosure relates to a digital video signal processing devices integrating gamma adjusting circuits of a liquid crystal display panels (LCDs).

Gamma correction improves LCD display quality. The brightness of specific gray levels is determined by gamma values adjusted by gamma correction to simulate lifelike display.

FIG. 1 shows an image signal processing system of a conventional LCD. Digital image signals are stored in display memory 10. In addition, a video signal may have many differing resolutions, but the resolution and pixel location of an LCD is fixed. A scaler 122 is required for image resolution adjustment. Thus, signals output from display memory 10 are scaled by scaler 122 according to the size of LCD panel 18.

U.S. Pat. No. 5,710,594 discloses a digital gamma correction method and apparatus. Gamma correction 120A adjusts display data brightness corresponding to the digital video signal.

In FIG. 1, conventional scaler 122 and gamma correction 120A are disposed on first circuit board 12. First circuit board 12 further includes on screen display device (OSD) 124 and micro control unit (MCU) 126 thereon. OSD 124 displays status information of specific parameters for adjusting the LCD. The specific parameters relates to brightness, contrast, and sync of the display. MCU 126 processes the video signal, including signal encoding or de-interlacer, and the display of OSD 124. Here, the circuits on first circuit board 12 process signaling between host PC and LCD module 100.

Next, signals processed by first circuit board 12 are applied to LCD module 100. LCD module 100 includes LCD driving circuit 16, LCD panel 18, and second circuit board 14 including timing controller 142. Timing controller 142 controls LCD driving circuit 16 to determine the display sequence and timing of the display cells in LCD panel 18.

LCD module 100 includes a second circuit board 14, connected between LCD driving circuit 16 and first circuit board 12, second circuit board 14 having gamma correction 120B thereon for adjusting the brightness of the video signal received by second circuit board 14.

LCD driving circuit 16 includes inversion circuit 162, digital-to-analog converter (DAC) 164, data driver 166A, and gate driver 166B. Inversion circuit 162 adjusts the display polarity of the liquid crystal molecules in the display cells. DAC 164 transforms the digital signal into analog video signal. In addition, LCD driving circuit 16 further includes gamma correction 120C for adjusting the brightness of the video signal providing to LCD panel 18.

FIG. 2 is a schematic circuit diagram showing conventional LCD driving circuit 16 and LCD panel 18.

LCD panel 18 is formed by interlacing data electrodes (represented by D1, D2 . . . ) and gate electrodes (represented by G1, G2 . . . ), each interlaced data electrode and gate electrode controls a display cell. As an example, interlaced data electrode D1 and gate electrode G1 control display cell 150. The equivalent circuit of each display cell includes thin film transistors (TFTs) (Q11, Q12, Q21, Q22, . . . ) and storage capacitors (C11, C12, C21, C22, . . . ). The gates and drains of the TFTs are respectively connected to gate electrodes and data electrodes. Such a connection can turn on/off all TFTs on the same line (i.e. positioned on the same scan line) using a scan signal of gate electrodes, thereby controlling the video signals of the data electrodes to be written into the corresponding display cell.

Gate driver 166B outputs one or more scan signals (also referred to as scan pulses) from each of the gate electrodes according to a predetermined sequence. When a scan signal is inputted to one gate electrode, the TFTs within all display cells on the same row (or scan line) are turned on while the TFTs within all display cells on other rows (or scan lines) are turned off. When a scan line is selected, data driver 166A outputs a video signal (gray value) to the display cells of the respective rows through corresponding data electrodes according to the image to be displayed. After gate driver 166B scans all rows continuously, the display of a single frame is completed. Thus, repeating scanning the display cells can achieve the purpose of continuously displaying an image.

However, in conventional LCD display systems, gamma corrections are set on first circuit board 12 having scaler 122 thereon, on second circuit board 14 having timing controller 142 thereon and on LCD driving circuit 16. Thus, additional space for locating circuits and as well cost for the circuits with similar function are required. In addition, the final data brightness influenced by each gamma correction complicates the gamma adjustment process.

### SUMMARY

Digital video signal processing devices for LCDs are provided. In one embodiment of the present invention, a digital video signal processing device comprises: a circuit board; a display memory for storing a digital image signal; a scaler disposed on the circuit board, for adjusting image size corresponding to the digital image signal and outputting a first display data; an LCD panel comprising a plurality of display cells, each being coupled to a corresponding data electrode and a gate electrode, for displaying an image in accordance with a second display data; an LCD driving circuit comprising a data driver and a gate driver for respectively driving the corresponding data electrode and gate electrode; a gamma correction disposed only on the circuit board for adjusting gamma values of the first display data and outputting the second display data.

In one embodiment of the present invention, a digital video signal processing device comprises: a display memory for storing a digital image signal; a scaler adapted to disposed on a first circuit board for adjusting image size corresponding to the digital image signal, and outputting a first display data; an LCD panel comprising a plurality of display cells respectively coupled to corresponding data electrodes and gate electrodes, for displaying an image according to a second display data; an LCD driving circuit comprising a data driver and a gate driver for respectively driving the corresponding data electrodes and gate electrodes; a gamma correction-correction adapted to disposed only on a second circuit board coupled between the first circuit board and the LCD driving circuit for adjusting gamma values of the first display data and outputting the second display data.

In one embodiment of the present invention, a digital video signal processing device comprises: a display memory for storing a digital image signal; a scaler adapted to disposed on a first circuit board, for adjusting image size corresponding to the -digital image signal, and outputting a first display data; an LCD module comprising an LCD panel comprising a plurality of display cells respectively coupled to corresponding data electrodes and gate electrodes, for displaying an image according to a second display data, an LCD driving circuit comprising a data driver and a gate driver for respectively driving the corresponding data electrodes and gate electrodes, and a second circuit board coupled between the LCD driving circuit and the scaler; a plurality of gamma correction disposed only on the first circuit board and the second circuit board, for adjusting gamma values of the first display data and outputting the second display data.

In one embodiment of the present invention, a digital video signal processing device comprises: a display memory for storing a digital image signal; an LCD module comprising an LCD panel comprising a plurality of display cells respectively coupled to corresponding data electrodes and gate electrodes, for displaying an image according to a display data; an LCD driving circuit comprising a data driver and a gate driver for respectively driving the corresponding data electrodes and gate electrodes; a timing controller disposed on a first circuit board for controlling the LCD driving circuit to determine display sequence and timing of the display cells; a gamma correction disposed only on the first circuit board, for adjusting gamma values of the display data and outputting the display data.

In one embodiment of the present invention, a digital video signal processing device comprises: a display memory for storing a digital image signal; an LCD module comprising an LCD panel comprising a plurality of display cells respectively coupled to corresponding data electrodes and gate electrodes, for displaying an image according to a display data; an LCD driving circuit comprising a data driver and a gate driver for respectively driving the corresponding data electrodes and gate electrodes and a timing controller adapted to disposed on a first circuit board for controlling the LCD driving circuit to determine display sequence and timing of the display cells; a gamma correction adapted to disposed only on a second circuit board coupled between the display memory and the LCD module, for adjusting gamma values of the display data and outputting the display data.

In one embodiment of the present invention, a digital video signal processing device comprises: a display memory for storing a digital image signal; an LCD module comprising an LCD panel comprising a plurality of display cells respectively coupled to corresponding data electrodes and gate electrodes, for displaying an image according to a display data, an LCD driving circuit comprising a data driver and a gate driver for respectively driving the corresponding data electrodes and gate electrodes and a timing controller disposed on a first circuit board for controlling the LCD driving circuit to determine display sequence and timing of the display cells; a second circuit board coupled between the display memory and the LCD module; a plurality of gamma corrections disposed on only two of the first circuit board, the second circuit board and the LCD driving circuit, for adjusting gamma values of the display data and outputting the display data.

In one embodiment of the present invention, a digital video signal processing device comprises: a display memory for storing a digital image signal; a scaler adapted to disposed on a first circuit board for adjusting image size corresponding to the digital image signal, and outputting a first display data; an LCD module comprising an LCD panel comprising a plurality of display cells respectively coupled to corresponding data electrodes and gate electrodes, for displaying an image according to a second display data, an LCD driving circuit comprising a data driver and a gate driver for respectively driving the corresponding data electrodes and gate electrodes, and a timing controller adapted to disposed on a second circuit board coupled to the first circuit board for controlling the LCD driving circuit to determine display sequence and timing of the display cells; a gamma correction disposed on only one of the first circuit board, the second circuit board and the LCD driving circuit, for adjusting gamma values of the first display data and outputting the second display data.

In one embodiment of the present invention, a digital video signal processing device comprises: a display memory for storing a digital image signal; a scaler adapted to disposed on a first circuit board for adjusting image size corresponding to the digital image signal, and outputting a first display data; an LCD module comprising an LCD panel comprising a plurality of display cells respectively coupled to corresponding data electrodes and gate electrodes, for displaying an image according to a second display data, an LCD driving circuit comprising a data driver and a gate driver for respectively driving the corresponding data electrodes and gate electrodes, and a timing controller adapted to disposed on a second circuit board for controlling the LCD driving circuit to determine display sequence and timing of the display cells; a plurality of gamma corrections disposed on only two of the first circuit board, the second circuit board and the LCD driving circuit, for adjusting gamma values of the first display data and outputting the second display data.

In one embodiment of the present invention, a digital video signal processing device comprises: a circuit board; a display memory for storing a digital image signal; a scaler disposed on the circuit board, for adjusting image size corresponding to the digital image signal and outputting a first display data; an LCD panel comprising a plurality of display cells, each being coupled to a corresponding data electrode and a gate electrode, for displaying an image in accordance with a second display data; an LCD driving circuit comprising a data driver and a gate driver for respectively driving the corresponding data electrode and gate electrode; a gamma correction disposed only on the LCD driving circuit for adjusting gamma values of the first display data and outputting the second display data.

In one embodiment of the present invention, a digital video signal processing device comprises: a display memory for storing a digital image signal; a scaler adapted to disposed on a first circuit board, for adjusting image size corresponding to the digital image signal, and outputting a first display data; an LCD module comprising an LCD panel comprising a plurality of display cells respectively coupled to corresponding data electrodes and gate electrodes, for displaying an image according to a second display data, an LCD driving circuit comprising a data driver and a gate driver for respectively driving the corresponding data electrodes and gate electrodes, and a second circuit board coupled between the LCD driving circuit and the scaler; a plurality of gamma correction disposed only on the second circuit board and the LCD driving circuit, for adjusting gamma values of the first display data and outputting the second display data.

In one embodiment of the present invention, a digital video signal processing device comprises: a display memory for storing a digital image signal; an LCD module comprising an LCD panel comprising a plurality of display cells respectively coupled to corresponding data electrodes and gate electrodes, for displaying an image according to a display data, an LCD driving circuit comprising a data driver and a gate driver for respectively driving the corresponding data electrodes and gate electrodes, and a timing controller disposed on a first circuit board for controlling the LCD driving circuit to determine display sequence and timing of the display cells; a gamma correction disposed only on the LCD driving circuit, for adjusting gamma values of the display data and outputting the display data.

### DESCRIPTION OF THE DRAWINGS

Various aspects of the invention will become more fully understood from the detailed description, given hereinafter, and the accompanying drawings. The drawings and description are provided for purposes of illustration only and, thus, are not intended to limit the present invention.

FIG. 1 shows an image signal processing system of a conventional LCD.

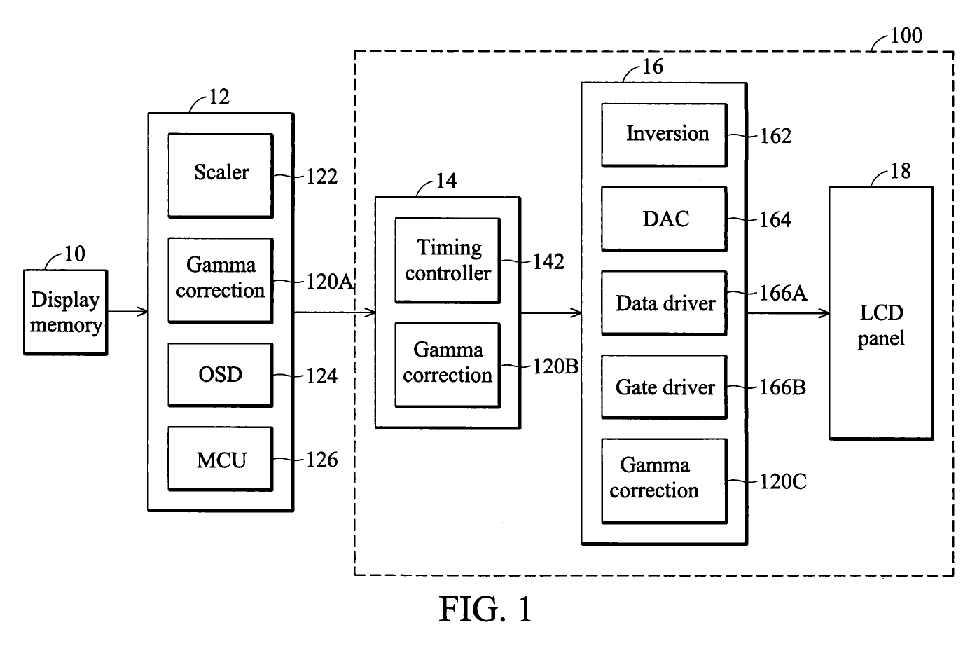

FIG. 2 is a schematic circuit diagram showing a conventional LCD driving circuit and an LCD panel.

FIG. 3 is a block diagram of a processing device for an LCD according to the first embodiment of the present invention.

FIG. 4 is a schematic circuit diagram showing LCD driving circuit and an LCD panel.

FIG. 5 is a block diagram of a processing device for an LCD according to the second embodiment of the present invention.

FIG. 6 is a block diagram of a processing device for an LCD according to the third embodiment of the present invention.

FIG. 7 is a block diagram of a processing device for an LCD according to the fourth embodiment of the present invention.

FIG. 8 is a block diagram of a processing device for an LCD according to the fifth embodiment of the present invention.

FIG. 9 is a block diagram of a processing device for an LCD according to the sixth embodiment of the present invention.

FIG. 10 is a block diagram of a processing device for an LCD according to the seventh embodiment of the present invention.

FIG. 11 is a block diagram of a processing device for an LCD according to the eighth embodiment of the present invention.

FIG. 12 is a block diagram of a processing device for an LCD according to the ninth embodiment of the present invention.

FIG. 13 is a block diagram of a processing device for an LCD according to the tenth embodiment of the present invention.

FIG. 14 is a block diagram of a processing device for an LCD according to the eleventh embodiment of the present invention.

FIG. 15 is a block diagram of a processing device for an LCD according to the twelfth embodiment of the present invention.

FIG. 16 is a block diagram of a processing device for an LCD according to the thirteenth embodiment of the present invention.

FIG. 17 is a block diagram of a processing device for an LCD according to the fourteenth embodiment of the present invention.

FIG. 18 is a block diagram of a processing device for an LCD according to the fifteenth embodiment of the present invention.

FIG. 19 is a block diagram of a processing device for an LCD according to the sixteenth embodiment of the present invention.

FIG. 20 is a block diagram of a processing device for an LCD according to the seventeenth embodiment of the present invention.

### DETAILED DESCRIPTION

First Embodiment

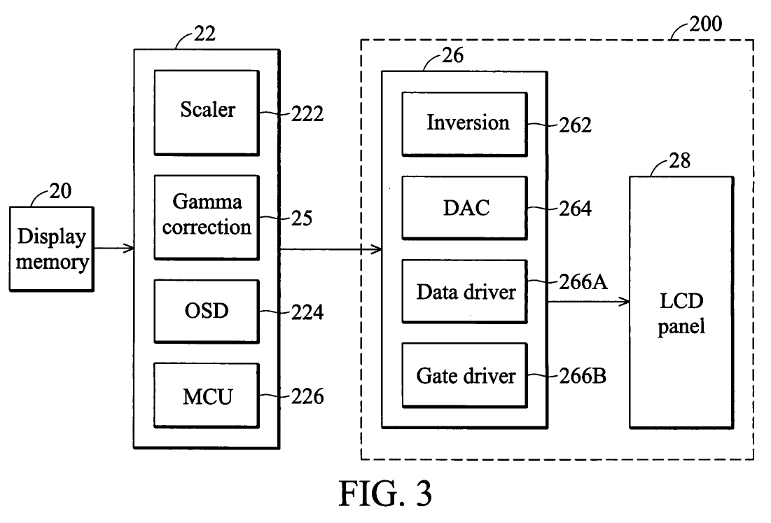

FIG. 3 is a block diagram of a processing device for an LCD according to the first embodiment of the present invention.

Digital image signals for display are stored in display memory 20. In addition, a video signal may have many differing resolutions, but the display resolution and pixel location of an LCD is determined when the TFT array is complete. A scaler is required for image resolution adjustment. Thus, signals output from display memory 20 are scaled by scaler 222 according to the size of LCD panel 28.

Gamma correction 25 adjusts gamma values of display data according to the digital video signal, disposed on first circuit board 22 with scaler 222. First circuit board 22 further includes on screen display device (OSD) 224 and micro control unit (MCU) 226 thereon. OSD 224 is for displaying status information of specific parameters for adjusting the LCD. The specific parameters relate to brightness, contrast, and sync of the display. MCU 226 processes the video signal, including signal encoding or de-interlacer, and the control of OSD 224 to display correct image or forms of a display character. Here, the circuits on first circuit board 22 process signaling between host PC and LCD module 200.

Next, signals processed by first circuit board 22 are applied to LCD module 200. LCD module 200 includes LCD driving circuit 26, and LCD panel 28.

LCD driving circuit 26 includes inversion circuit 262, digital-to-analog converter (DAC) 264, data driver 266A, and gate driver 266B. Inversion circuit 262 adjusts the display polarity of the liquid crystal molecules in the display cells. DAC 264 transforms the digital signal provided from second circuit board 24 to LCD driving circuit 26 into analog video signal.

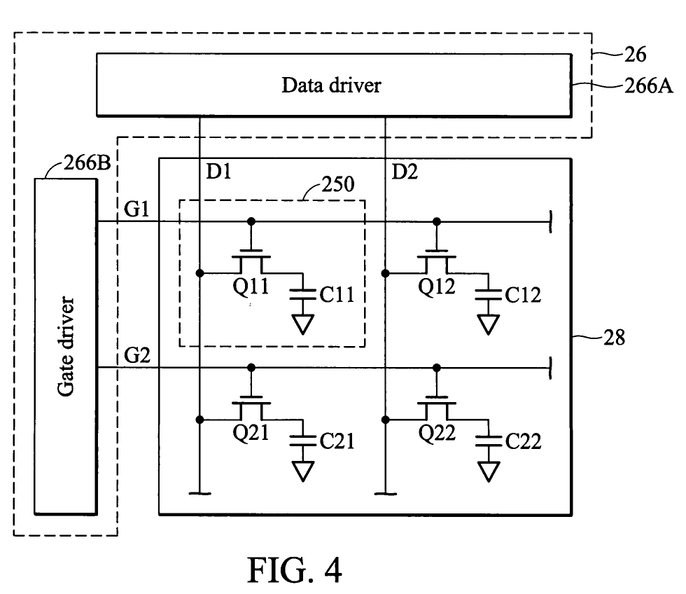

FIG. 4 is a schematic circuit diagram showing LCD driving circuit 26 and LCD panel 28.

LCD panel 28 includes interlacing data electrodes (represented by D1, D2 . . . ) and gate electrodes (represented by G1, G2 . . . ), each interlaced data electrode and gate electrode controls a display cell. As an example, interlaced data electrode D1 and gate electrode G1 control display cell 250. The equivalent circuit of each display cell includes thin film transistors (TFTs) (Q11, Q12, Q21, Q22, . . . ) and storage capacitors (C11, C12, C21, C22 . . . ). The gates and drains of the TFTs are respectively connected to gate electrodes and data electrodes. Such a connection can turn on/off all TFTs on the same line (i.e. positioned on the same scan line) using a scan signal inputted to gate electrodes, thereby controlling the video signals of the data electrodes to be written into the corresponding display cell.

In addition, gate driver 266B outputs one or more scan signals (also referred to as scan pulses) to each of the gate electrodes according to a predetermined sequence. When a scan signal is inputted to one gate electrode, the TFTs all display cells on the same row (or scan line) are turned on while the TFTs all display cells on other rows (or scan lines) are turned off. When a scan line is selected, data driver 266A outputs a video signal (gray value) to the display cells of the respective rows through corresponding data electrodes according to the image to be displayed. After gate driver 266B scans all rows continuously, the display of a single frame is completed. Thus, repeating scanning all display cells achieves the purpose of continuously displaying an image.

In the embodiment shown in FIG. 3, the gamma value of an LCD display system is adjusted by a single gamma correction 25 disposed on first circuit board 22 outside the LCD module 200, thus, gamma adjustment in LCD module 200 is omitted, eliminating additional space and cost requirements in LCD module 200 for gamma correction as in conventional technology. In addition, gamma adjustment is simplified because only a single gamma correction is implemented, avoiding gamma values of image influenced by a plurality of gamma corrections of the conventional technology.

Second Embodiment

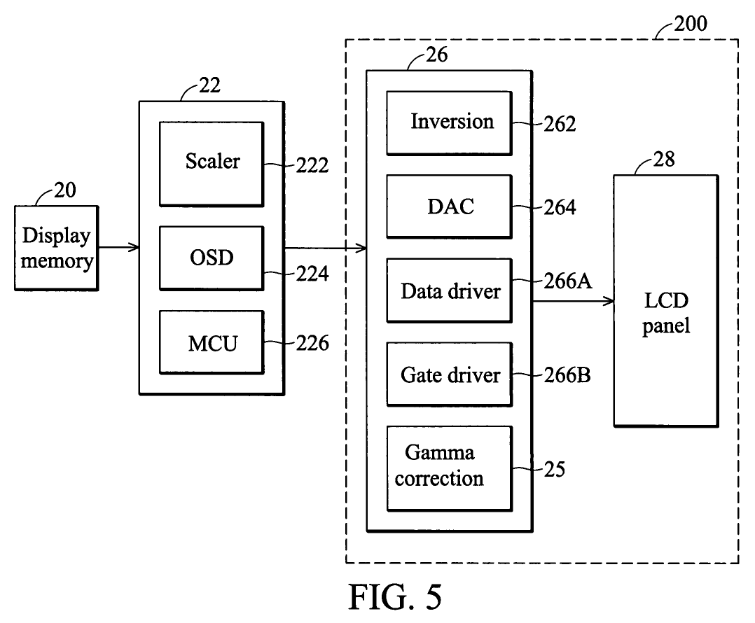

FIG. 5 is a block diagram of a processing device for an LCD according to the second embodiment of the present invention. Note that the elements in FIG. 5 corresponding to those in FIG. 3 share the same reference numerals, and explanation thereof is omitted to simplify the description.

In the embodiment shown in FIG. 5, gamma correction 25 is disposed on the LCD driving circuit 26 of LCD module 200 to adjust gamma values of display data according to the digital video signal received from first circuit board 22. In this embodiment, first circuit board 22 has no gamma correction thereon. In addition, the video signal processed by gamma correction 25 is transformed to an analog video signal by DAC 264, then the analog video signal is inputted to corresponding data electrode. Thus, LCD panel 28 displays the image with gamma values corresponding to the video signal.

In addition, the gamma value of an LCD display system is adjusted by a single gamma correction 25. In this embodiment, only LCD module 200 includes gamma correction 25 thereon, thus, gamma adjustment in first circuit board 22 outside the LCD module 200 is omitted, eliminating additional space and cost requirements for gamma correction as in conventional technology. In addition, gamma adjustment is simplified because only a single gamma correction is implemented, avoiding gamma values of data influenced by a plurality of gamma corrections of the conventional technology.

Third Embodiment

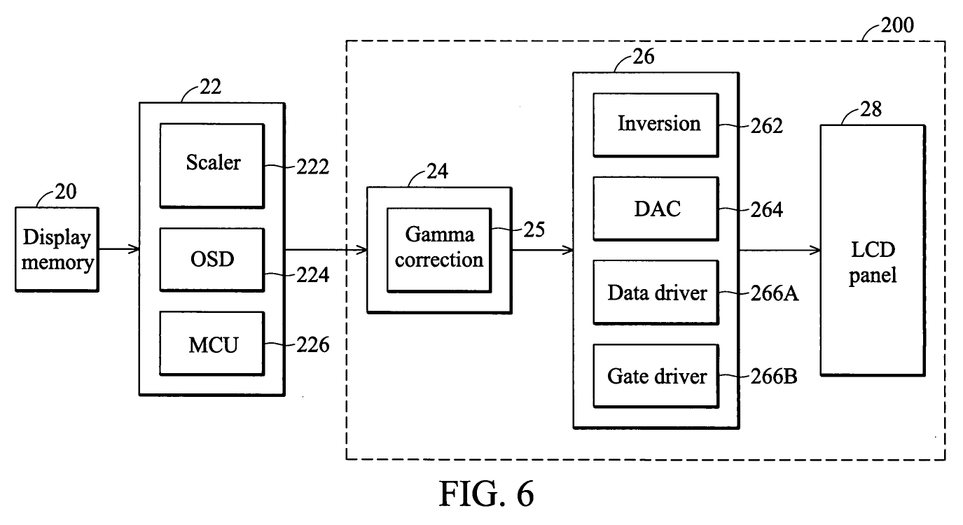

FIG. 6 is a block diagram of a processing device for an LCD according to the third embodiment of the present invention. Note that the elements in FIG. 6 corresponding to those in FIG. 3 share the same reference numerals, and explanation thereof is omitted to simplify the description.

In the embodiment shown in FIG. 6, second circuit board 24 is added in LCD module 200, connected between LCD driving circuit 26 and first circuit board 22 outside LCD module 200, for configuring the gamma correction 25 disposed on the second circuit board 22, to adjust display gamma values of data accroding to the digital video signal received by second circuit board 24. In this embodiment, first circuit board 22 has no gamma correction. In addition, the video signal processed by gamma correction 25 is provided to LCD driving circuit 26, after converting by DAC 264, the video signal is provided to corresponding data electrode. Thus, LCD panel 28 displays the image with gamma values corresponding to the video signal.

In addition, the gamma value of an LCD display system is adjusted by a single gamma correction 25. In this embodiment, only LCD module 200 includes gamma correction 25 thereon, thus, gamma adjustment in first circuit board 22 outside the LCD module 200 is omitted, eliminating additional space and cost requirements for gamma correction as in conventional technology. In addition, gamma adjustment is simplified because only a single gamma correction is implemented, avoiding gamma values of data influenced by a plurality of gamma corrections of the conventional technology.

Fourth Embodiment

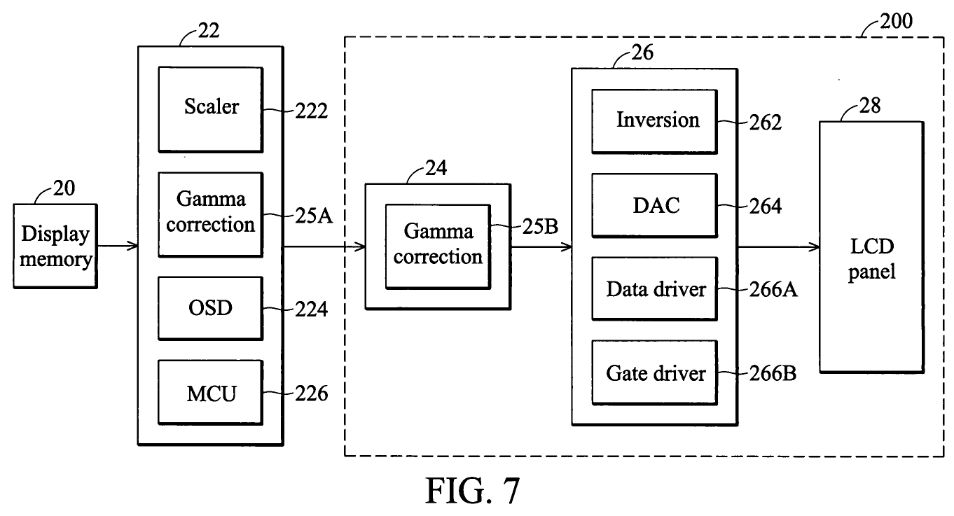

FIG. 7 is a block diagram of a processing device for an LCD according to the fourth embodiment of the present invention. Note that the elements in FIG. 7 corresponding to those in FIG. 3 share the same reference numerals, and explanation thereof is omitted to simplify the description.

In the embodiment shown in FIG. 7, second circuit board 24 is disposed in LCD module 200, connected between LCD driving circuit 26 and first circuit board 22 outside LCD module 200, for configuring the gamma correction 25B to adjust gamma values of display data according to the digital video signal received by second circuit board 24. Thus, the gamma values of the image displayed by LCD panel 28 is adjusted by gamma corrections 25A and 25B disposed on first circuit board 22 and second circuit board 24 respectively, and gamma adjustment in LCD driving circuit 26 is omitted.

In addition, the video signal processed by gamma correction 25B is provided to LCD driving circuit 26, and after converting by DAC 264, the video signal is provided to corresponding data electrode. Thus, LCD panel 28 displays the image with gamma values corresponding to the video signal.

In addition, gamma value of an LCD display system is adjusted by gamma corrections 25A and 25B. In this embodiment, gamma adjustment in LCD driving circuit 26 is omitted, eliminating additional space and cost requirements for gamma correction as in conventional technology.

Fifth Embodiment

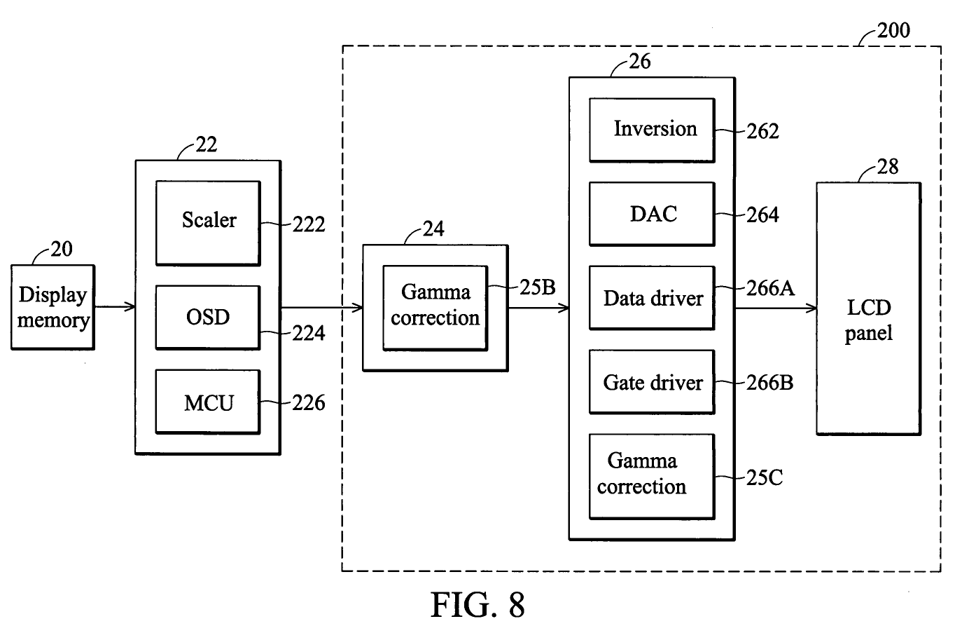

FIG. 8 is a block diagram of a processing device for an LCD according to the fifth embodiment of the present invention. Note that the elements in FIG. 8 corresponding to those in FIG. 6 share the same reference numerals, and explanation thereof is omitted to simplify the description.

In the embodiment shown in FIG. 8, second circuit board 24 is added in LCD module 200, connected between LCD driving circuit 26 and first circuit board 22 outside LCD module 200, for configuring the gamma correction 25B to adjust gamma values of display data according to the digital video signal provided to second circuit board 24. In addition, LCD driving circuit 26 further includes gamma correction 25C thereon to adjust gamma values of display data according to the digital video signal received from second circuit board 24. Thus, the gamma values of the image displayed by LCD panel 28 is adjusted by gamma corrections 25B and 25C disposed on second circuit board 24 and LCD driving circuit 26 respectively, and gamma adjustment in first circuit board 22 is omitted.

In addition, gamma value of an LCD display system is adjusted by gamma corrections 25B and 25C. In this embodiment, gamma adjustment in first circuit board 22 is omitted, eliminating additional space and cost requirements for gamma correction as in conventional technology.

Sixth Embodiment

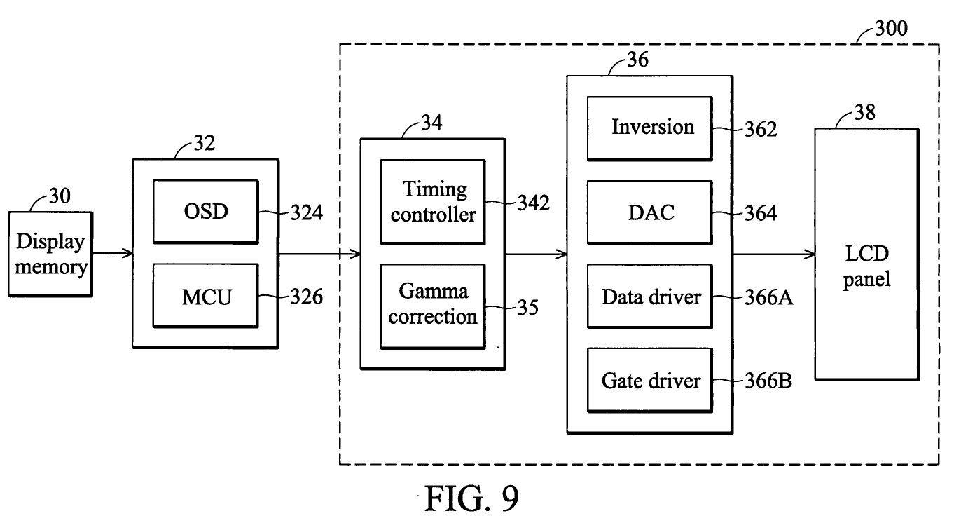

FIG. 9 is a block diagram of a processing device for an LCD according to the sixth embodiment of the present invention. Digital image signals for display are stored in display memory 30. Second circuit board 32 includes on screen display device (OSD) 324 thereon. If necessary, second circuit board 32 further includes micro control unit (MCU) 326 thereon. OSD 324 is for displaying status information of specific parameters for adjusting the LCD. The specific parameters related to brightness, contrast, and sync of the display. MCU 326 processes the video signal, comprising signal encoding or de-interlacer, and the display of OSD 324. Here, the circuits on second circuit board 32 process signaling between host PC and LCD module 300.

Next, signals processed by second circuit board 32 are applied to LCD module 300. LCD module 300 includes LCD driving circuit 36, LCD panel 38, and first circuit board 34 comprising timing controller 342 thereon. Timing controller 342 controls LCD driving circuit 36 to determine the display sequence and timing of the display cells in LCD panel 38.

LCD module 300 includes a first circuit board 34, connected between LCD driving circuit 36 and second circuit board 32 outside LCD module 300, having gamma correction 35 thereon for adjusting the gamma values of the video signal received by first circuit board 34.

LCD driving circuit 36 includes inversion circuit 362, digital-to-analog converter (DAC) 364, data driver 366A, and gate driver 366B thereon. Inversion circuit 362 adjusts the display polarity of the liquid crystal molecules in the display cells. DAC 364 transforms the digital signal provided from LCD driving circuit 36 into analog video signal and inputs the analog video signal to the corresponding data electrode of LCD panel 38.

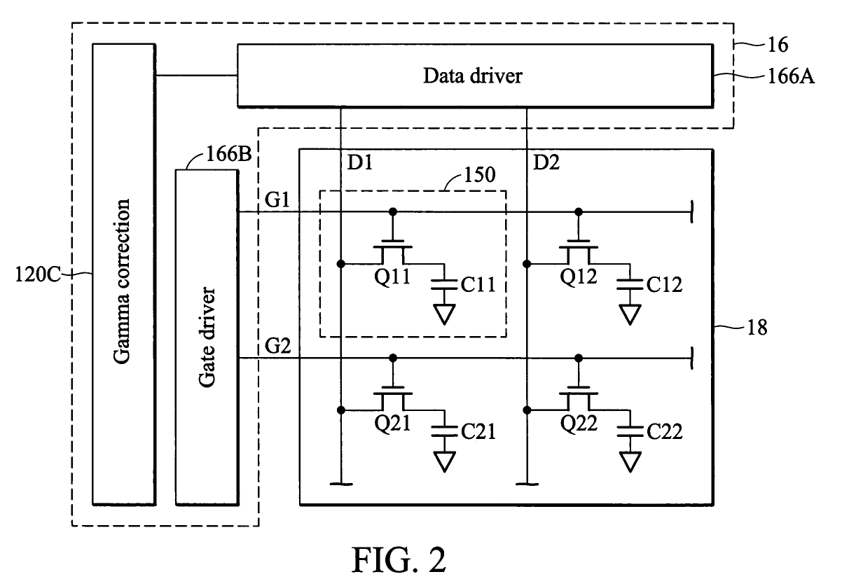

The description of data driver 366A and gate driver 366B of LCD driving circuit 36 and LCD panel 38 is shown in FIG. 2, and explanation thereof is omitted to simplify the description.

In the embodiment shown in FIG. 9, the gamma value of an entire LCD display system is adjusted by a single gamma correction 35. In this embodiment, only LCD module 300 includes gamma correction 35 thereon, thus, gamma adjustment in second circuit board 32 outside the LCD module 300 is omitted, eliminating additional space and cost requirements for gamma correction as in conventional technology. In addition, gamma adjustment is simplified because only a single gamma correction is implemented, avoiding gamma values of data influenced by a plurality of gamma corrections of the conventional technology.

Seventh Embodiment

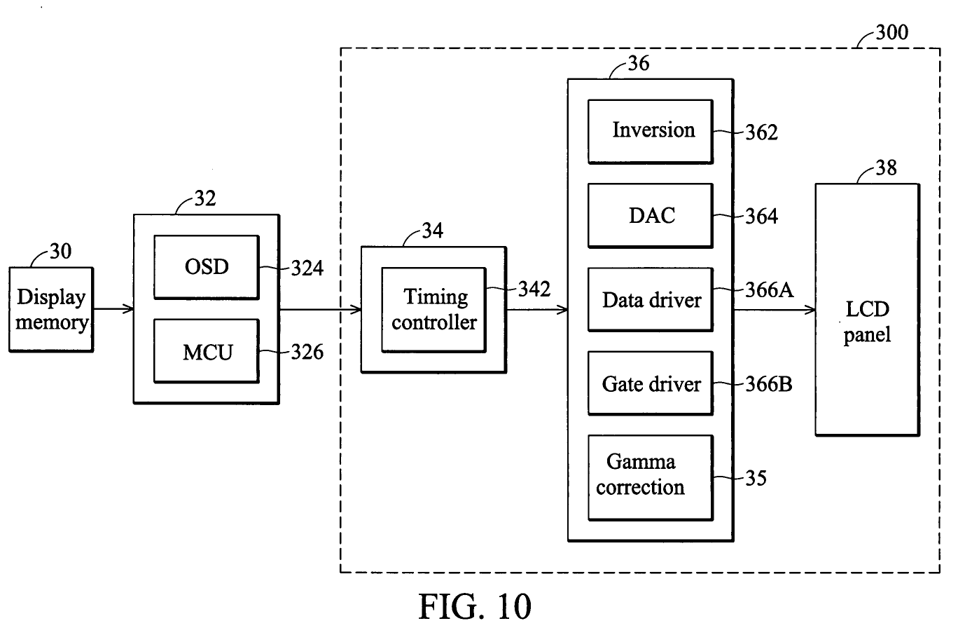

FIG. 10 is a block diagram of a processing device for an LCD according to the seventh embodiment of the present invention. Note that the elements in FIG. 10 corresponding to those in FIG. 9 share the same reference numerals, and explanation thereof is omitted to simplify the description.

In the embodiment shown in FIG. 10, gamma correction 25 is disposed on LCD driving circuit 36 of LCD module 300 to adjust gamma values of display data according to the digital video signal received by second circuit board 32. In this embodiment, first circuit board 34 has no gamma correction thereon. In addition, the video signal is processed by gamma correction 35 of LCD driving circuit 36, after converting to an analog video signal by DAC 364, the analog video signal is provided to corresponding data electrode. Thus, LCD panel 38 displays the image with gamma values corresponding to the video signal.

In addition, the gamma value of an LCD display system is adjusted by a single gamma correction 35. In this embodiment, LCD module 300 includes gamma correction 35 thereon, thus, gamma adjustment in first circuit board 34 of the LCD module 300 is omitted, eliminating additional space and cost requirements for gamma correction as in conventional technology. In addition, gamma adjustment is simplified because only a single gamma correction is implemented, avoiding gamma values of data influenced by a plurality of gamma corrections of the conventional technology.

Eighth Embodiment

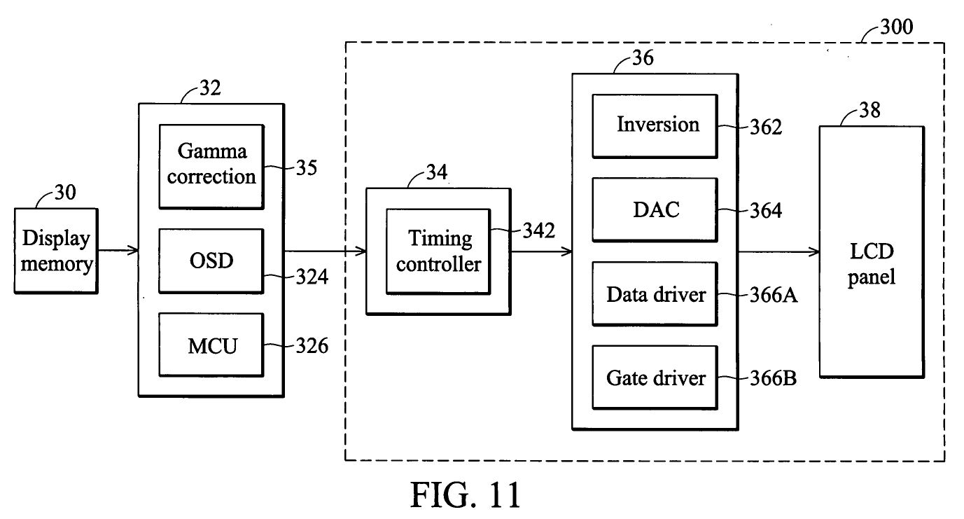

FIG. 11 is a block diagram of a processing device for an LCD according to the eighth embodiment of the present invention. Note that the elements in FIG. 11 corresponding to those in FIG. 9 share the same reference numerals, and explanation thereof is omitted to simplify the description.

In the embodiment shown in FIG. 11, the gamma value of an entire LCD display system is adjusted by a single gamma correction 35. In this embodiment, gamma correction 35 is disposed on the second circuit board 32 outside LCD module 300. Thus, gamma adjustment is performed directly by gamma correction 35. In addition, gamma adjustment in LCD module 300 is omitted, eliminating additional space and cost requirements for gamma correction as in conventional technology. In addition, gamma adjustment is simplified because only a single gamma correction is implemented, avoiding gamma values of data influenced by a plurality of gamma corrections of the conventional technology.

Ninth Embodiment

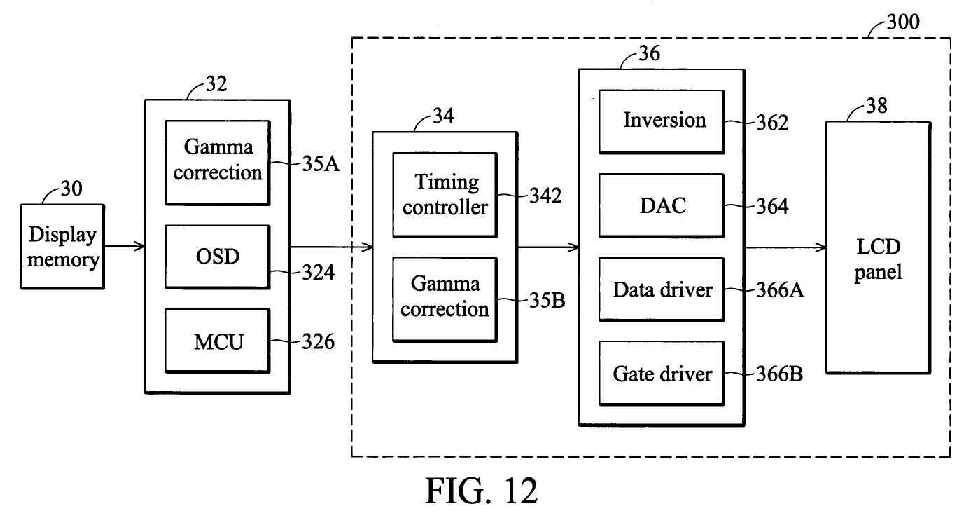

FIG. 12 is a block diagram of a processing device for an LCD according to the ninth embodiment of the present invention. Note that the elements in FIG. 12 corresponding to those in FIG. 9 share the same reference numerals, and explanation thereof is omitted to simplify the description.

In the embodiment shown in FIG. 12, gamma correction 35A is added to second circuit board 32 to adjust display gamma values of data according to the digital video signal received by second circuit board 32. Thus, the gamma values of the image displayed by LCD panel 38 is adjusted by gamma corrections 35A and 35B disposed on second circuit board 32 and first circuit board 34 respectively, and gamma adjustment in LCD driving circuit 36 is omitted.

In addition, the video signal processed by gamma correction 35B is provided to LCD driving circuit 36, and after the video signal is converted by DAC 364 to an analog video signal, the analog video signal is inputted to corresponding data electrode. Thus, LCD panel 38 displays the image with gamma values corresponding to the video signal.

In addition, gamma value of entire LCD display system is adjusted by gamma corrections 35A and 35B. In this embodiment, gamma adjustment in LCD driving circuit 36 is omitted, eliminating additional space and cost requirements for gamma correction as in conventional technology.

Tenth Embodiment

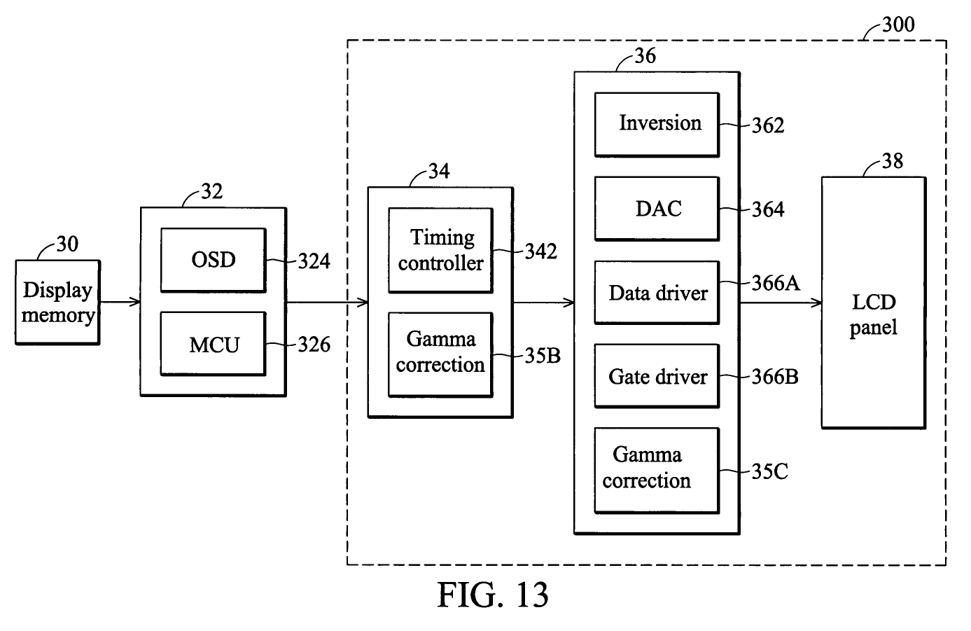

FIG. 13 is a block diagram of a processing device for an LCD according to the tenth embodiment of the present invention. Note that the elements in FIG. 13 corresponding to those in FIG. 9 share the same reference numerals, and explanation thereof is omitted to simplify the description.

In the embodiment shown in FIG. 13, gamma correction 35C is added to LCD driving circuit 36 to adjust display gamma values of data according to the digital video signal provided to LCD panel 38. Thus, the gamma values of the image displayed by LCD panel 38 is adjusted by gamma corrections 35B and 35C disposed on first circuit board 34 and LCD driving circuit 36 respectively, and gamma adjustment in second circuit board 32 is omitted.

In addition, gamma adjustment is only performed in LCD module 300 by gamma corrections 35B and 35C. In this embodiment, gamma adjustment in second circuit board 32 is omitted, eliminating additional space and cost requirements for gamma correction as in conventional technology.

Eleventh Embodiment

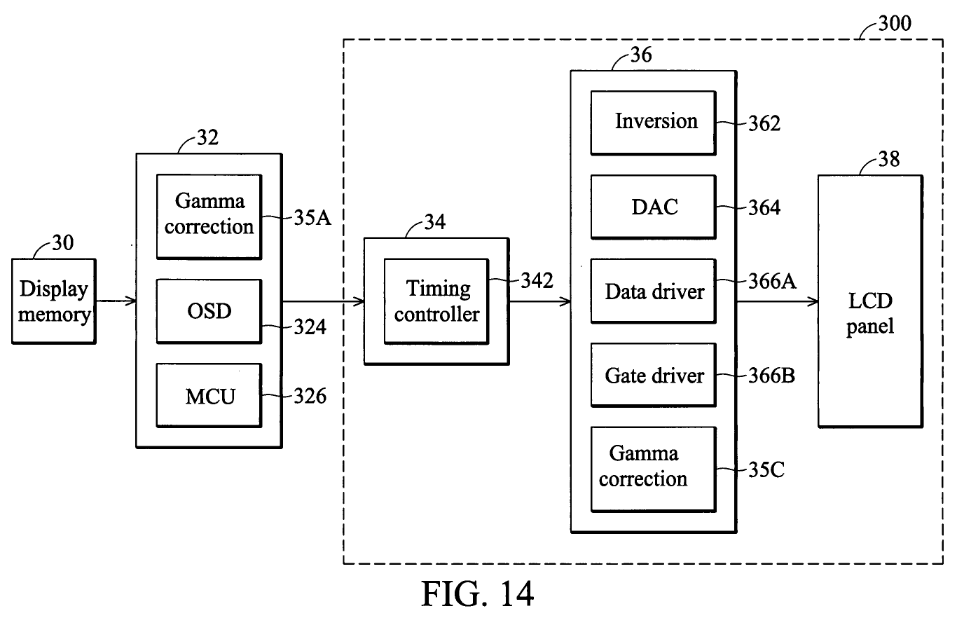

FIG. 14 is a block diagram of a processing device for an LCD according to the eleventh embodiment of the present invention. Note that the elements in FIG. 14 corresponding to those in FIG. 9 share the same reference numerals, and explanation thereof is omitted to simplify the description.

In the embodiment shown in FIG. 14, gamma correction 35A is added to second circuit board 32 to adjust gamma values of display data according to the digital video signal received by second circuit board 32. In addition, gamma correction 35C is also added to LCD driving circuit 36 to adjust gamma values of display data according to the digital video signal provided to LCD panel 38. Thus, the gamma values of the image displayed by LCD panel 38 is adjusted by gamma corrections 35A and 35C respectively on second circuit board 32 and LCD driving circuit 36, and gamma adjustment in first circuit board 34 is omitted.

In addition, gamma value of entire LCD display system is adjusted by gamma corrections 35A and 35C. In this embodiment, gamma adjustment in first circuit board 34 is omitted, eliminating additional space and cost requirements for gamma correction as in conventional technology.

Twelfth Embodiment

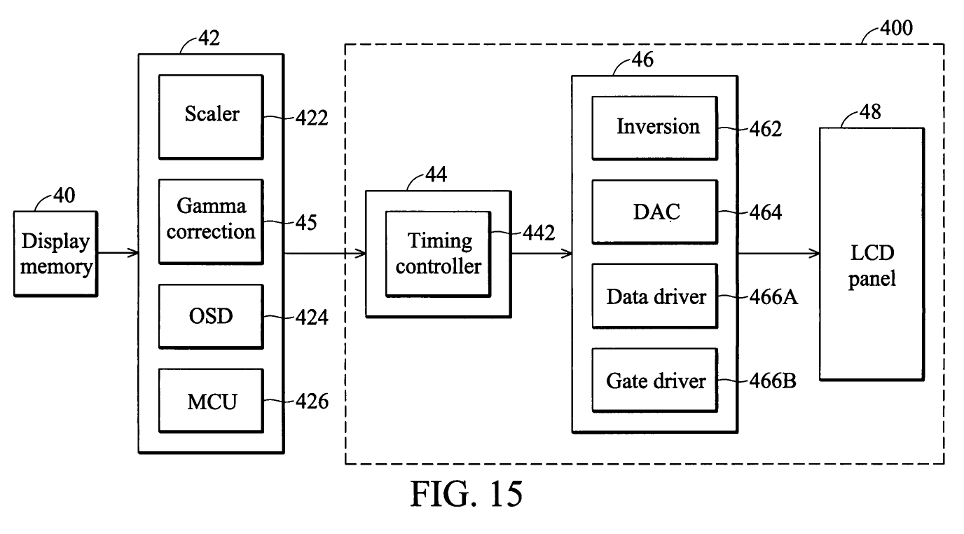

FIG. 15 is a block diagram of a processing device for an LCD according to the twelfth embodiment of the present invention. Digital image signals for display are stored in display memory 40. In addition, a video signal may have many differing resolutions, but the display resolution and pixel location of an LCD is determined when the TFT array is complete. A scaler is required for image resolution adjustment. Thus, signals output from display memory 40 are scaled by scaler 422 according to the size of LCD panel 48, wherein the scaler 422 is disposed on the first circuit board 42.

Gamma correction 45 adjusts gamma values of display data according to the digital video signal, which is disposed on first circuit board 42. First circuit board 42 further includes on screen display device (OSD) 424 and micro control unit (MCU) 426 thereon. OSD 424 is for displaying status information of specific parameters for adjusting the LCD. The specific parameters relates to brightness, contrast, and sync of the display. MCU 426 processes the video signal, comprising signal encoding or de-interlacer, and the display of OSD 424. Here, the circuits on first circuit board 42 process signaling between host PC and LCD module 400.

Signals processed by first circuit board 42 are then applied to LCD module 400. LCD module 400 includes LCD driving circuit 46, LCD panel 48, and second circuit board 44 thereon, wherein the second circuit board 44 includes timing controller 442 thereon. Timing controller 442 controls LCD driving circuit 46 to determine the display sequence and timing of the display cells in LCD panel 48. Second circuit board 44 is connected between LCD driving circuit 46 and first circuit board 42 outside LCD module 400.

LCD driving circuit 46 includes inversion circuit 462, digital-to-analog converter (DAC) 464, data driver 466A, and gate driver 466B thereon. Inversion circuit 462 adjusts the display polarity of the liquid crystal molecules in the display cells. DAC 464 transforms the digital signal provided from LCD driving circuit 46 into an analog video signal and inputs the analog video signal to the corresponding data electrode of LCD panel 48.

The description of data driver 466A and gate driver 466B of LCD driving circuit 46 and LCD panel 48 is shown in FIG. 2, and explanation thereof is omitted to simplify the description.

In the embodiment shown in FIG. 15, the gamma value of an LCD display system is adjusted by a single gamma correction 45. In this embodiment, gamma correction 45 is disposed on the first circuit board 42 outside LCD module 400. Thus, gamma adjustment is performed directly by gamma correction 45. In addition, gamma adjustment in LCD module 400 is omitted, eliminating additional space and cost requirements for gamma correction as in conventional technology. In addition, gamma adjustment is simplified because only a single gamma correction is implemented, avoiding gamma values of image influenced by a plurality of gamma corrections of the conventional technology.

Thirteenth Embodiment

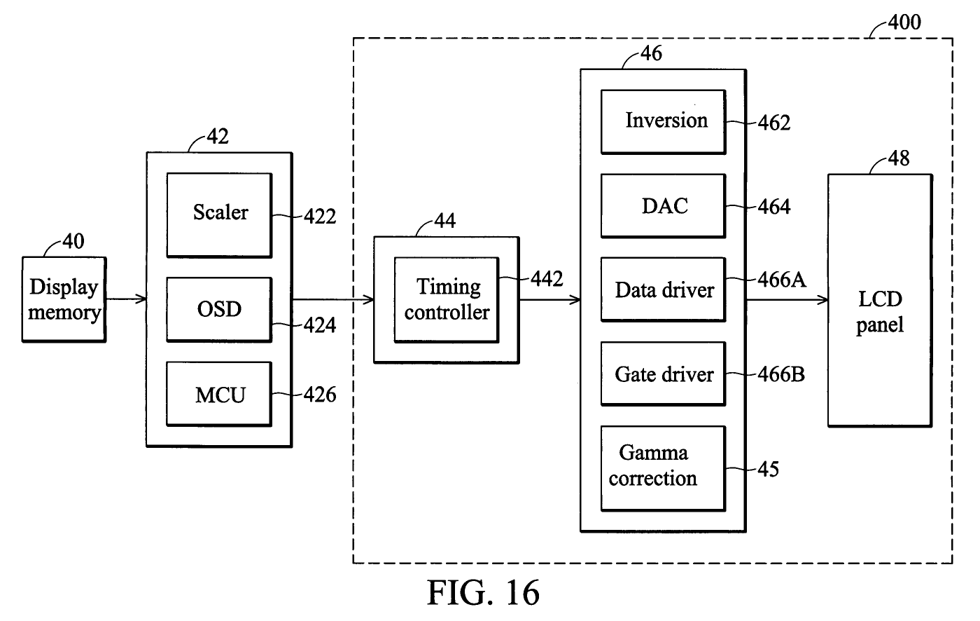

FIG. 16 is a block diagram of a processing device for an LCD according to the thirteenth embodiment of the present invention. Note that the elements in FIG. 16 corresponding to those in FIG. 15 share the same reference numerals, and explanation thereof is omitted to simplify the description.

In the embodiment shown in FIG. 16, gamma correction 45 is disposed on LCD driving circuit 46 of LCD module 400 to adjust gamma values of display data according to the digital video signal received by second circuit board 44. In this embodiment, first circuit board 42 has no gamma correction thereon. In addition, the video signal is processed by gamma correction 45 of LCD driving circuit 46, and after the video signal is converted to an analog video signal by DAC 464, the analog video signal is provided to corresponding data electrode. Thus, LCD panel 48 displays the image with gamma values corresponding to the video signal.

In addition, the gamma value of an entire LCD display system is adjusted by a single gamma correction 45. In this embodiment, only LCD module 400 includes gamma correction 45, thus, gamma adjustment in first circuit board 42 is omitted, eliminating additional space and cost requirements for gamma correction as in conventional technology. In addition, gamma adjustment is simplified because only a single gamma correction is implemented, avoiding gamma values of image influenced by a plurality of gamma corrections of the conventional technology.

Fourteenth Embodiment

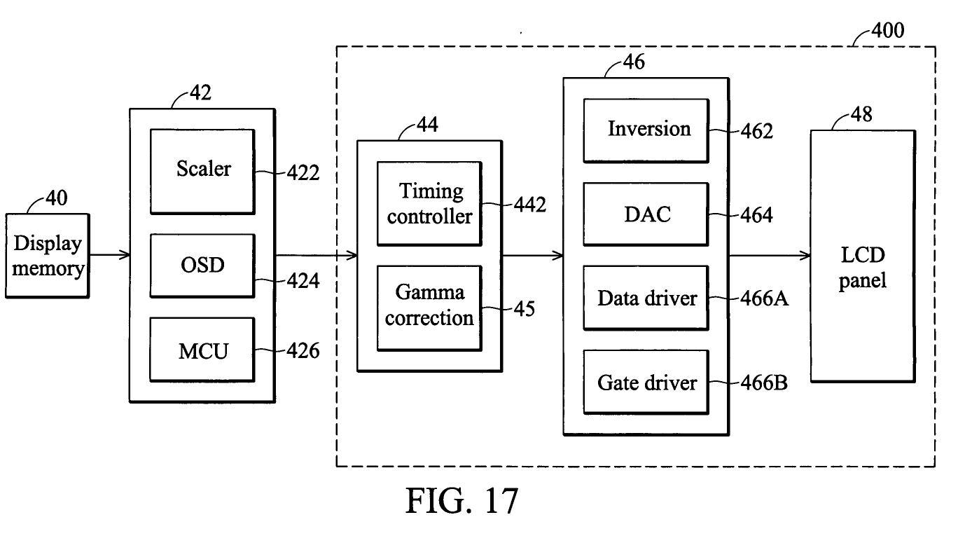

FIG. 17 is a block diagram of a processing device for an LCD according to the fourteenth embodiment of the present invention. Note that the elements in FIG. 17 corresponding to those in FIG. 15 share the same reference numerals, and explanation thereof is omitted to simplify the description.

In the embodiment shown in FIG. 17, gamma correction 45 is disposed on second circuit board 44 to adjust gamma values of display data according to the digital video signal received by second circuit board 44. In this embodiment, first circuit board 42 has no gamma correction.

In addition, the gamma value of an LCD display system is adjusted by a single gamma correction 45. In this embodiment, only LCD module 400 includes gamma correction 45 thereon, thus, gamma adjustment in first circuit board 42 outside the LCD module 400 is omitted, eliminating additional space and cost requirements for gamma correction as in conventional technology. In addition, gamma adjustment is simplified because only a single gamma correction is implemented, avoiding gamma values of image influenced by a plurality of gamma corrections of the conventional technology.

Fifteenth Embodiment

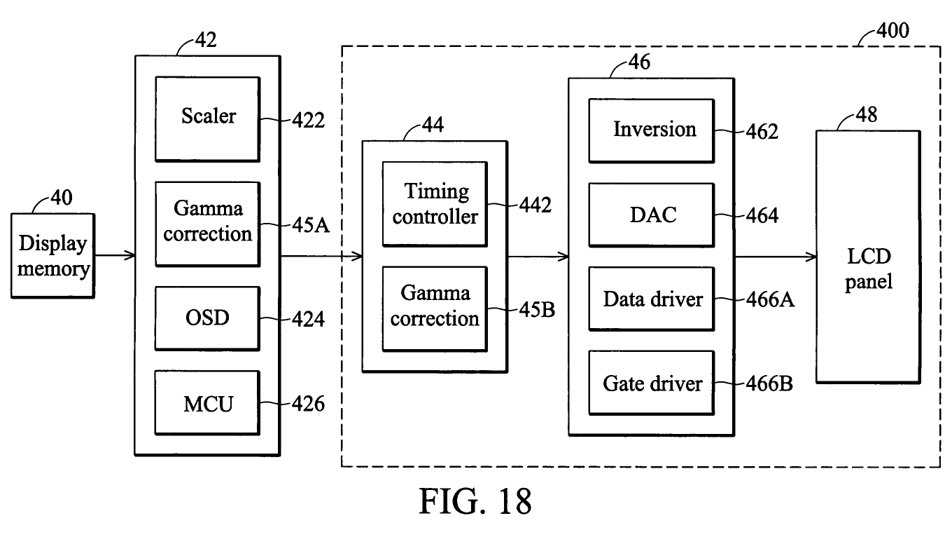

FIG. 18 is a block diagram of a processing device for an LCD according to the fifteenth embodiment of the present invention. Note that the elements in FIG. 18 corresponding to those in FIG. 15 share the same reference numerals, and explanation thereof is omitted to simplify the description.

In the embodiment shown in FIG. 18, second circuit board 44 further includes gamma correction 45B, connected between LCD driving circuit 46 and first circuit board 42 outside LCD module 400, to adjust gamma values of display data according to the digital video signal received by second circuit board 44. Thus, the gamma values of the image displayed by LCD panel 48 is adjusted by gamma corrections 45A and 45B disposed on first circuit board 42 and second circuit board 44 respectively, and gamma adjustment in LCD driving circuit 46 is omitted.

In addition, the video signal processed by gamma correction 45B of second circuit board 44 is provided to LCD driving circuit 46, and after the video signal is converted by DAC 464 into an analog video signal, the analog video signal is inputted to corresponding data electrode. Thus, LCD panel 48 displays the image with gamma values corresponding to the video signal.

In addition, gamma value of an LCD display system is adjusted by gamma corrections 45A and 45B. In this embodiment, gamma adjustment in LCD driving circuit 46 is omitted, eliminating additional space and cost requirements for gamma correction as in conventional technology.

Sixteenth Embodiment

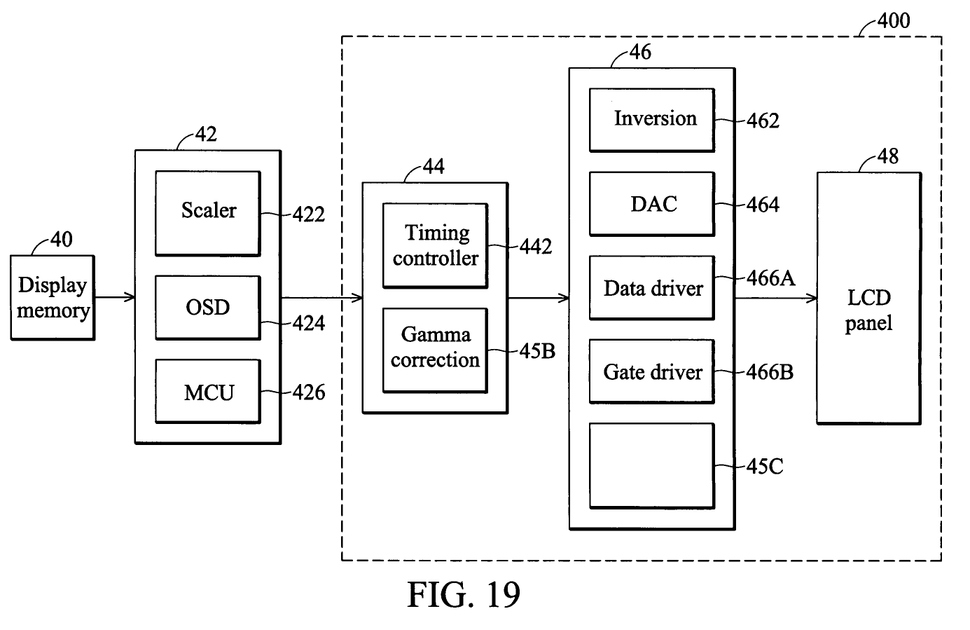

FIG. 19 is a block diagram of a processing device for an LCD according to the sixteenth embodiment of the present invention. Note that the elements in FIG. 19 corresponding to those in FIG. 15 share the same reference numerals, and explanation thereof is omitted to simplify the description.

In the embodiment shown in FIG. 19, LCD driving circuit 46 further includes gamma correction 45C thereon to adjust gamma values of display data according to the digital video signal provided by second circuit board 44. Thus, the gamma values of the image displayed by LCD panel 48 is adjusted by gamma corrections 45B and 45C disposed on second circuit board 44 and LCD driving circuit 46 respectively, and gamma adjustment in first circuit board 42 is omitted.

In addition, gamma adjustment is only performed in LCD module 400 by gamma corrections 45B and 45C. In this embodiment, gamma adjustment in first circuit board 42 is omitted, eliminating additional space and cost requirements for gamma correction as in conventional technology.

Seventeenth Embodiment

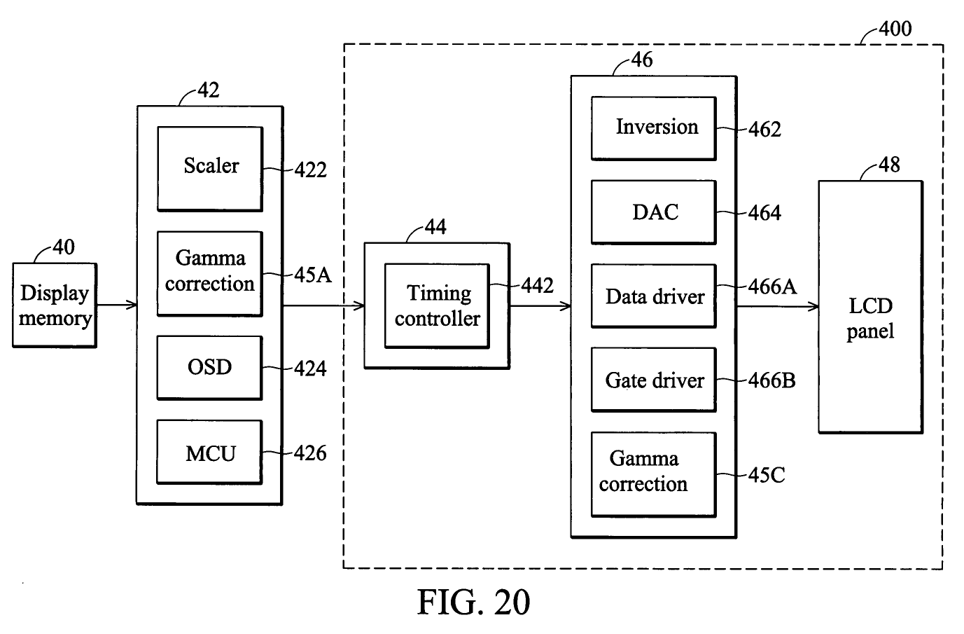

FIG. 20 is a block diagram of a processing device for an LCD according to the seventeenth embodiment of the present invention. Note that the elements in FIG. 20 corresponding to those in FIG. 15 share the same reference numerals, and explanation thereof is omitted to simplify the description.

In the embodiment shown in FIG. 20, gamma correction 45A is added to first circuit board 42 to adjust gamma values of display data according to the digital video signal received by first circuit board 42. In addition, gamma correction 45C is added to LCD driving circuit 46 to adjust gamma values of display data according to the digital video signal. Thus, the gamma values of the image displayed by LCD panel 48 is adjusted by gamma corrections 45A and 45C disposed on first circuit board 42 and LCD driving circuit 46 respectively, and gamma adjustment in second circuit board 44 is omitted.

In addition, gamma value of an LCD display system is adjusted by gamma corrections 45A and 45C. In this embodiment, gamma adjustment in second circuit board 44 is omitted, eliminating additional space and cost requirements for gamma correction as in conventional technology.

Embodiments of the invention provide a plurality of LCD display systems corresponding to different display systems with specific functions. In addition, embodiments of the invention improve integration of the LCDs with specific size. For example, an LCD with small size usually requires lower resolution, thus its gamma corrections and timing controller can be integrated with the DAC; an LCD with large size usually requires higher resolution, thus its gamma corrections and timing controller can be integrated with the scaler outside the LCD module, and its DAC can be integrated with the LCD driving circuit of the LCD module.

Thus, embodiments of the invention provide digital video signal processing devices with different integration structures, eliminating additional space and cost requirements for gamma correction as in conventional technology. In addition, gamma adjustment is simplified by the digital video signal processing devices according to the embodiments of the invention.

The foregoing description of the preferred embodiments have been presented for purposes of illustration and description. Obvious modifications or variations are possible in light of the above teaching. The embodiments were chosen and described to provide the best illustration of the principles of the invention and its practical application to thereby enable those skilled in the art to utilize the various embodiments and their various modifications, as are suited to the particular use contemplated. All such modifications and variations are within the scope of the present invention.

1. A digital video signal processing device, comprising:
a first circuit board;
a display memory for storing a digital image signal;
a scaler disposed on the first circuit board, for adjusting image size corresponding to the digital image signal and outputting a first display data;
an LCD panel comprising a plurality of display cells, each being coupled to a corresponding data electrode and a gate electrode, for displaying an image in accordance with a second display data;
an LCD driving circuit comprising a data driver and a gate driver for respectively driving the corresponding data electrode and gate electrode; and
a gamma correction disposed only on the first circuit board for adjusting gamma values of the first display data and outputting the second display data.

2. The digital video signal processing device as claimed in claim 1, wherein the LCD driving circuit further comprises an inversion circuit for adjusting display polarity of the display cells.

3. The digital video signal processing device as claimed in claim 1, wherein the LCD driving circuit further comprises a digital-to-analog converter for transforming the second display data to an analog signal, and outputting the analog signal to the corresponding data electrode.

4. The digital video signal processing device as claimed in claim 1, further comprising an on screen display device disposed on the first circuit board, for displaying status information of specific parameters.

5. The digital video signal processing device as claimed in claim 4, further comprising a micro control unit disposed on the first circuit board for processing image display and controlling the on screen display device.

6. The digital video signal processing device as claimed in claim 1, further comprising a micro control unit disposed on the first circuit board for processing image display.

7. The digital video signal processing device as claimed in claim 1, further comprising:
a second circuit board disposed between the first circuit board and the LCD driving circuit; and
a timing controller disposed on the second circuit board, for controlling the LCD driving circuit to determine display sequence and timing of the display cells.

8. A digital video signal processing device, comprising:
a first circuit board;
a display memory for storing a digital image signal;
a scaler disposed on the first circuit board, for adjusting image size corresponding to the digital image signal and outputting a first display data;
an LCD panel comprising a plurality of display cells, each being coupled to a corresponding data electrode and a gate electrode, for displaying an image in accordance with a second display data;
an LCD driving circuit comprising a data driver and a gate driver for respectively driving the corresponding data electrode and gate electrode;
a second circuit board disposed between the first circuit board and the LCD driving circuit; and
a gamma correction disposed only on the second circuit board for adjusting gamma values of the first display data and outputting the second display data.

9. The digital video signal processing device as claimed in claim 8, wherein the LCD driving circuit further comprises an inversion circuit for adjusting display polarity of the display cells.

10. The digital video signal processing device as claimed in claim 8, wherein the LCD driving circuit further comprises a digital-to-analog converter for transforming the display data to an analog signal, and outputting the analog signal to the corresponding data electrode.

11. The digital video signal processing device as claimed in claim 8, further comprising an on screen display device disposed on the first circuit board, for displaying status information of specific parameters.

12. The digital video signal processing device as claimed in claim 11, further comprising a micro control unit disposed on the first circuit board for processing image display and controlling the on screen display device.

13. The digital video signal processing device as claimed in claim 8, further comprising a micro control unit disposed on the first circuit board for processing image display.

14. The digital video signal processing device as claimed in claim 8, further comprising a timing controller disposed on the second circuit board, for controlling the LCD driving circuit to determine display sequence and timing of the display cells.

15. The digital video signal processing device as claimed in claim 14, wherein the LCD driving circuit further comprises an inversion circuit for adjusting display polarity of the display cells.

16. The digital video signal processing device as claimed in claim 14, wherein the LCD driving circuit further comprises a digital-to-analog converter for transforming the display data to an analog signal, and outputting the analog signal to the corresponding data electrode.

17. The digital video signal processing device as claimed in claim 14, further comprising an on screen display device disposed on the first circuit board, for displaying status information of specific parameters.

18. The digital video signal processing device as claimed in claim 17, further comprising a micro control unit disposed on the first circuit board for processing image display and controlling the on screen display device.

19. The digital video signal processing device as claimed in claim 14, further comprising a micro control unit disposed on the first circuit board for processing image display.

20. A digital video signal processing device, comprising:
a first circuit board;
a display memory for storing a digital image signal;
an LCD panel comprising a plurality of display cells, each being coupled to a corresponding data electrode and a gate electrode, for displaying an image in accordance with a second display data;
an LCD driving circuit comprising a data driver and a gate driver for respectively driving the corresponding data electrode and gate electrode;
a second circuit board disposed between the first circuit board and the LCD driving circuit;
a timing controller disposed on the second circuit board; and
a gamma correction disposed only on the second circuit board, for adjusting gamma values of the first display data and outputting the second display data.

21. The digital video signal processing device as claimed in claim 20, further comprising an on screen display device disposed on the first circuit board, for displaying status information of specific parameters.

22. The digital video signal processing device as claimed in claim 21, further comprising a micro control unit disposed on the first circuit board for processing image display and controlling the on screen display device.

23. The digital video signal processing device as claimed in claim 20, further comprising a micro control unit disposed on the first circuit board for processing image display.

24. The digital video signal processing device as claimed in claim 20, wherein the LCD driving circuit further comprises an inversion circuit for adjusting display polarity of the display cells.

25. The digital video signal processing device as claimed in claim 20, wherein the LCD driving circuit further comprises a digital-to-analog converter for transforming the display data to an analog signal, and outputting the analog signal to the corresponding data electrode.

26. A digital video signal processing device, comprising:
a first circuit board;
a display memory for storing a digital image signal;
a scaler disposed on the first circuit board, for adjusting image size corresponding to the digital image signal and outputting a first display data;
an LCD panel comprising a plurality of display cells, each being coupled to a corresponding data electrode and a gate electrode, for displaying an image in accordance with a second display data;
an LCD driving circuit comprising a data driver and a gate driver for respectively driving the corresponding data electrode and gate electrode;
a second circuit board disposed between the first circuit board and the LCD driving circuit; and
a plurality of gamma corrections disposed only on the first and second circuit boards for adjusting gamma values of the first display data and outputting the second display data.

27. The digital video signal processing device as claimed in claim 26, wherein the LCD driving circuit further comprises an inversion circuit for adjusting display polarity of the display cells.

28. The digital video signal processing device as claimed in claim 26, wherein the .LCD driving circuit further comprises a digital-to-analog converter for transforming the display data to an analog signal, and outputting the analog signal to the corresponding data electrode.

29. The digital video signal processing device as claimed in claim 26, further comprising an on screen display device disposed on the first circuit board, for displaying status information of specific parameters.

30. The digital video signal processing device as claimed in claim 29, further comprising a micro control unit disposed on the first circuit board for processing image display and controlling the on screen display device.

31. The digital video signal processing device as claimed in claim 26, further comprising a micro control unit disposed on the first circuit board for processing image display.

32. A digital video signal processing device, comprising:
a first circuit board;
a display memory for storing a digital image signal;
an LCD panel comprising a plurality of display cells, each being coupled to a corresponding data electrode and a gate electrode, for displaying an image in accordance with a second display data;
an LCD driving circuit comprising a data driver and a gate driver for respectively driving the corresponding data electrode and gate electrode;
a second circuit board disposed between the first circuit board and the LCD driving circuit;
a timing controller disposed on the second circuit board; and
a plurality of gamma corrections disposed only on the first and second circuit boards for adjusting gamma values of the first display data and outputting the second display data.

33. The digital video signal processing device as claimed in claim 32, wherein the LCD driving circuit further comprises an inversion circuit for adjusting display polarity of the display cells.

34. The digital video signal processing device as claimed in claim 32, wherein the LCD driving circuit further comprises a digital-to-analog converter for transforming the display data to an analog signal, and outputting the analog signal to the corresponding data electrode.

35. The digital video signal processing device as claimed in claim 32, further comprising an on screen display device disposed on the first circuit board, for displaying status information of specific parameters.

36. The digital video signal processing device as claimed in claim 35, further comprising a micro control unit disposed on the first circuit board for processing image display and controlling the on screen display device.

37. The digital video signal processing device as claimed in claim 32, further comprising a micro control unit disposed on the first circuit board for processing image display.

38. The digital video signal processing device as claimed in claim 32, further comprising a scaler disposed on the first circuit board, for adjusting image size corresponding to the digital image signal and outputting a first display data.

39. A digital video signal processing device, comprising:
a first circuit board;
a display memory for storing a digital image signal;
an LCD panel comprising a plurality of display cells, each being coupled to a corresponding data electrode and a gate electrode, for displaying an image in accordance with a second display data;
an LCD driving circuit comprising a data driver and a gate driver for respectively driving the corresponding data electrode and gate electrode;
a second circuit board disposed between the first circuit board and the LCD driving circuit;
a timing controller disposed on the second circuit board, for controlling the LCD driving circuit to determine display sequence and timing of the display cells; and
a gamma correction disposed only on the first circuit board for adjusting gamma values of the first display data and outputting the second display data.

40. The digital video signal processing device as claimed in claim 39, wherein the LCD driving circuit further comprises an inversion circuit for adjusting display polarity of the display cells.

41. The digital video signal processing device as claimed in claim 39, wherein the LCD driving circuit further comprises a digital-to-analog converter for transforming the second display data to an analog signal, and outputting the analog signal to the corresponding data electrode.

42. The digital video signal processing device as claimed in claim 39, further comprising an on screen display device disposed on the first circuit board, for displaying status information of specific parameters.

43. The digital video signal processing device as claimed in claim 42, further comprising a micro control unit disposed on the first circuit board for processing image display and controlling the on screen display device.

44. The digital video signal processing device as claimed in claim 39, further comprising a micro control unit disposed on the first circuit board for processing image display.
